(19) United States
(12) Patent Application Publication
(10) Pub. No.: US 2020/0052771 A1
(43) Pub. Date: Feb. 13, 2020

(54) METHODS AND SYSTEMS FOR DIGITAL BEAMFORMING

(71) Applicant: MaxLinear, Inc., Carlsbad, CA (US)

(72) Inventor: Curtis Ling, Carlsbad, CA (US)

(21) Appl. No.: 16/657,725

(22) Filed: Oct. 18, 2019

Related U.S. Application Data
(63) Continuation of application No. 16/005,295, filed on Jun. 11, 2018, now abandoned.
(60) Provisional application No. 62/517,976, filed on Jun. 11, 2017.

(51) Int. Cl. H04B 7/08; H04B 7/06; H04B 7/0408

(52) U.S. Cl. CPC H04B 7/0868; H04B 7/0408; H04B 7/0617; H04B 7/086

(57) ABSTRACT

Systems and methods are provided for utilizing antenna arrays with digital beamforming. An array-based system may have a plurality of antenna elements arranged in a two-dimensional array, and a plurality of transceiver chips configured for handling transmission and reception of radio frequency (RF) signals via the plurality of antenna elements. A number of transceiver chips in the plurality of transceiver chips may be less than a number of antenna elements in the plurality of antenna elements. The plurality of transceiver chips is configured to control operation of the plurality of antenna elements such that digital or hybrid beamforming is enabled during the transmission and reception of RF signals via the plurality of antenna elements.

### CLAIM OF PRIORITY

This patent application is a continuation of U.S. patent application Ser. No. 16/005,295, filed on Jun. 11, 2018, which makes reference to, claims priority to and claims benefit from U.S. Provisional Patent Application Ser. No. 62/517,976, filed on Jun. 11, 2017. Each of the above identified application is hereby incorporated herein by reference in its entirety.

### TECHNICAL FIELD

Aspects of the present disclosure relate to communications solutions. More specifically, certain implementations of the present disclosure relate to methods and systems for a digital beamforming.

### BACKGROUND

Various issues may exist with conventional approaches for transmission and reception of signals, such as microwave signals and millimeter waves (mmW) signals. In this regard, conventional dish-based transmit/receive systems and methods for use thereof may be costly, inefficient, and/or ineffective.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for a digital beamforming, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 illustrates an example dish-based system.

FIG. 2 illustrates an example digital beamforming array-based system, in accordance with the present disclosure.

FIGS. 3A-3C illustrate different array architecture designs that may be used in beamforming array-based systems.

FIG. 4A illustrates an example chip-level architecture for use in a digital beamforming array-based system, in accordance with the present disclosure.

FIG. 4B illustrates an example transceiver chip for use in a digital beamforming based architecture, in accordance with the present disclosure.

FIG. 4C illustrates example data flows in chip-level architecture during digital beamforming, in accordance with the present disclosure.

FIGS. 5A-5B illustrate example improvements in digital beamforming array-based systems, in accordance with the present disclosure.

FIG. 6 illustrates a cross-section in an example digital beamforming array-based system, in accordance with the present disclosure, showing material stack-up in such system.

FIGS. 7A-7B illustrate examples of simulated array radiation in a digital beamforming array-based system, in accordance with the present disclosure.

FIG. 8 illustrates examples use scenario of interference cancellation for higher frequency reuse using digital beamforming array-based systems, in accordance with the present disclosure.

FIGS. 9A-9B illustrate an example of interference (sidelobe) cancellation simulation in digital beamforming array-based systems, in accordance with the present disclosure.

FIG. 10 illustrate examples use scenario of multi-point-to-multi-point transmissions using digital beamforming array-based systems, in accordance with the present disclosure.

FIG. 11 illustrates performance comparison between hybrid beamforming based design and digital beamforming based design.

FIG. 12 illustrates performance comparison between dish-duplexer based design and digital beamforming based design.

FIG. 13 illustrates example profiles of different antenna classes.

FIG. 14 illustrates example nonuniform array configuration, in accordance with the present disclosure.

### DETAILED DESCRIPTION OF THE INVENTION

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

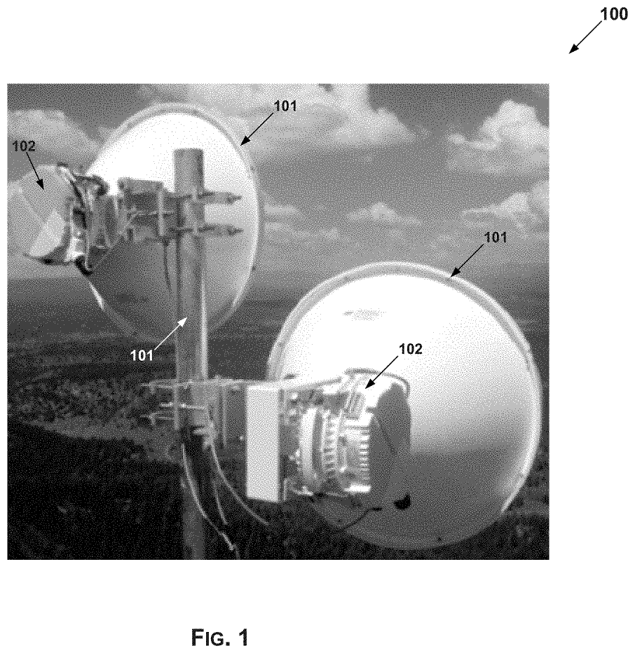

FIG. 1 illustrates an example dish-based system. Shown in FIG. 1 is an example dish-based system 100. In this regard, the dish-based system 100 may be configured for use as backhaul, such as in conventional wireless solutions (e.g., 4G or 5G networks).

The dish-based system 100 may comprise one or more dishes 101 (each being, e.g., a parabolic reflector) and corresponding boxes 102 each associated with one dish 101. The box 102 may house circuitry for facilitating transmission and reception of signals via the dish 101. For example, the box 102 may circuitry for generating the radio frequency (RF) signals, for emission via the dish 102, during transmission operations, and circuitry for handling the reception of RF signals captured via the dish during reception operations. Further, each box 102 may incorporate additional component, such as a frequency duplexer (for isolating transmission and reception of signal via the common dish), a large power amplifier, etc. The boxes 102 are typically attached or coupled to the back (or base) of the dishes 101.

Because of bulkiness and weight, dish based systems are installed in limited manner—e.g., to a post 103, as shown in FIG. 1, which may be specifically built to support the weight of the dish-based elements. Further, the hardware components used in such systems (e.g., boxes 102) require a lot of circuitry, which further results in high power consumption and (due to certain circuit elements, such as the power amplifiers) large heat sinks.

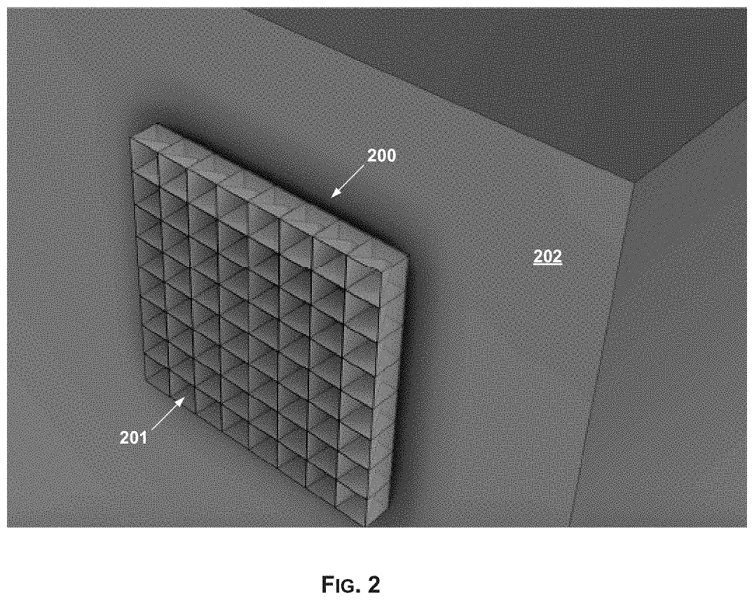

FIG. 2 illustrates an example digital beamforming array-based system, in accordance with the present disclosure. Shown in FIG. 2 is an example digital beamforming array-based system 200, representing an example implementation in accordance with the proposed solution.

The digital beamforming array-based system 200 may be designed and/or implemented based on use of beamforming via an array of antenna elements. In this regard, rather than use a single dish, a number of antenna elements, arranged in 2-dimensional array, would be used to transmit and receive signals. The transmission and reception of signals may be done using beamforming, which may be particularly configured for addressing possible issues (interference, etc.) and/or to provide added features, as described below. Further, the digital beamforming array-based system 200 may be designed and implemented to utilize digital signals, which allow for use of minimal circuitry.

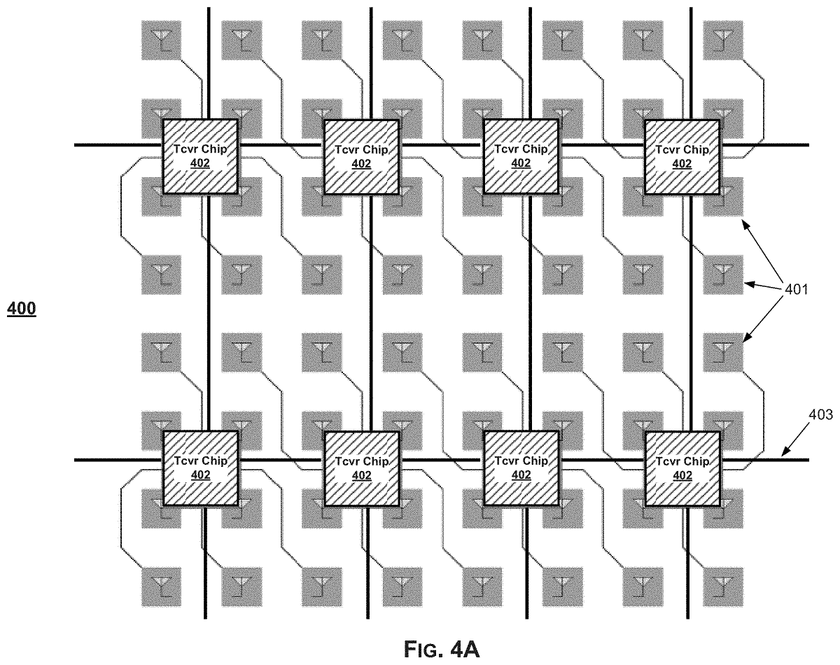

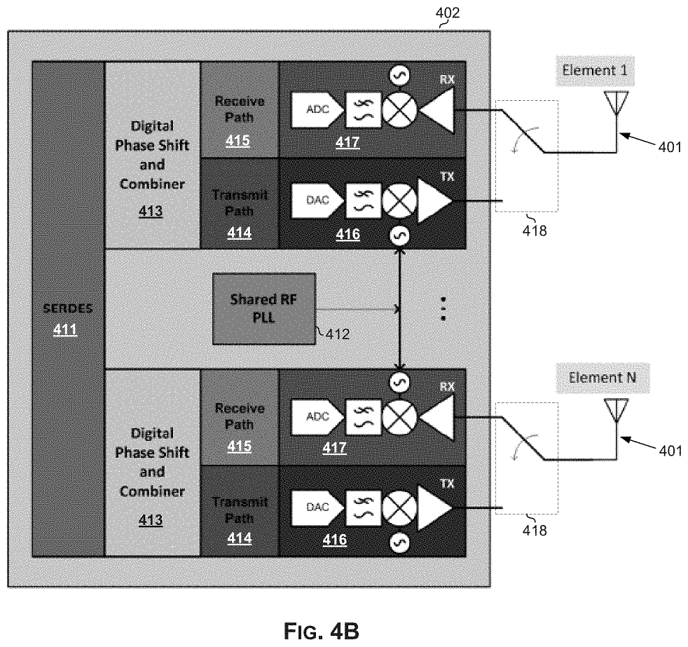

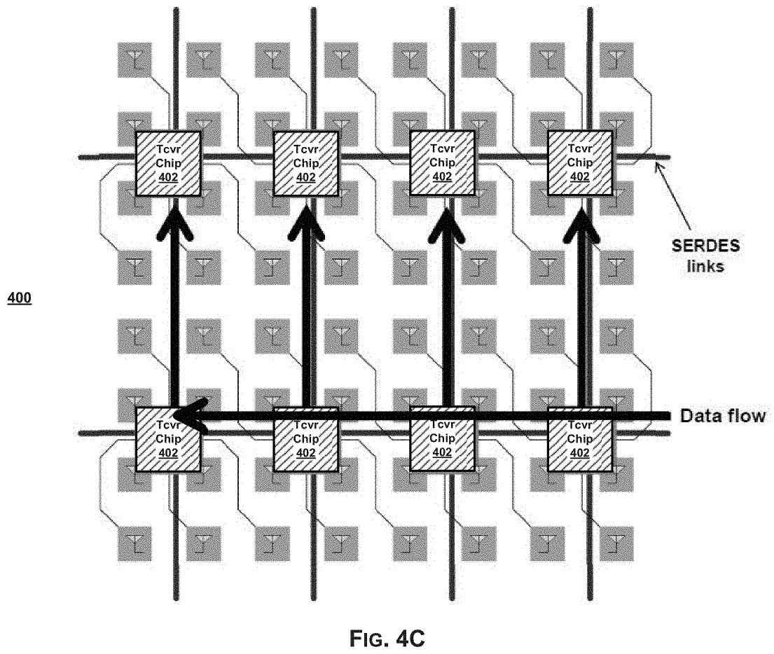

For example, as shown in FIG. 2, the digital beamforming array-based system 200 may comprise an array of antenna elements 201 (e.g., 64 elements, in 8×8 arrangement, as shown in the non-limiting example implementation illustrated in FIG. 2). The digital beamforming array-based system 200 comprises chip-based (e.g., system on chip (SoC), printed circuit board (PCB), etc.) circuitry incorporated into the antenna array architecture itself. An example of such architecture is described in more detail below, with respect to FIG. 4A.

Digital beamforming array-based systems (e.g., the digital beamforming array-based system 200) may be optimized for light-weight, small form factor, and use of beam steering. Thus, such systems may be installed in more flexible manner—e.g., allowing for wall mounting as shown in FIG. 2 (the system 200 being mounted to a wall of building 203). This allows for elimination of dish and related components (e.g., the frequency duplexer, large PA, etc.), and allows for wider range of sites, lower cost of installation and operation (e.g., automatic alignment).

Accordingly, digital beamforming array-based systems implemented in accordance with the present disclosure may have various advantages and/or may allow for various improvements over traditional dish-based designs. In this regard, digital beamforming array-based systems may allow for lower implementation costs (e.g., fewer, smaller, and less expensive circuits, etc.) and for greater function. Also, the use of software-defined multiband array operation adds more flexibility.

For example, the elimination of certain components (e.g., duplexers) allows the array-based systems to operate across a wide frequency range. Greater link reach may be achieved for same dish size (due to, e.g., greater transmitter power, interference suppression, etc.). Operations may be improved (e.g., lower operating expenditure, greater frequency reuse, lower weight, lower moment, lower sideload, etc.). Further, digital beamforming array-based systems may have superior thermal dissipation characteristics. In addition, same core technology may be utilized for 5G 28/38/39 GHz arrays, allowing for common software and hardware development.

For example, digital beamforming array-based systems may offer scalable transmit (Tx) power (e.g., >30 dBm) and improved equivalent isotropically radiated power (EIRP) (e.g., >40 dBW proportional to cost). In this regard, a smaller dish may be used to span greater link distances. These systems also yield lower system weights in comparison to conventional systems (e.g., 6kg for an array-based system like system 200 of FIG. 2 vs. 22 kg for 0.6 m dish based systems (including the dish and related hardware, including duplexer, radio, etc.)). The weight reduction may lead to significantly-reduced moment, site loading, site rental fees, and shipping costs.

Reliability may also be increased (e.g., due to lower operating heat, increased built-in system redundancy and fail-over, etc.). In addition, the array-based systems may allow for higher capacity through greater frequency reuse and dense deployments (e.g., due to transmit (Tx) and receive (Rx) interference cancellation, dynamic frequency planning, etc.). Finally, the array-based systems may result in signification deduction of manufacturing costs.

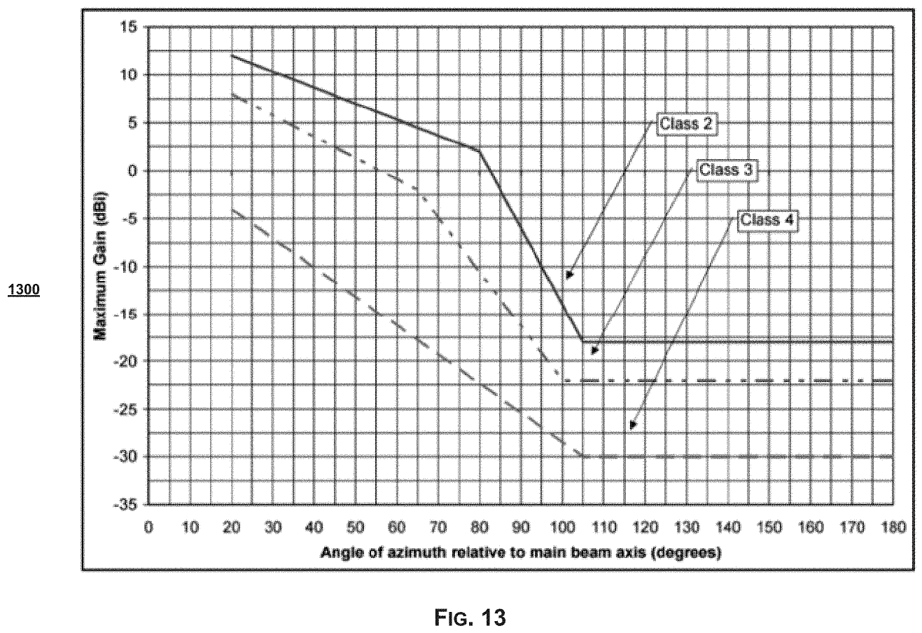

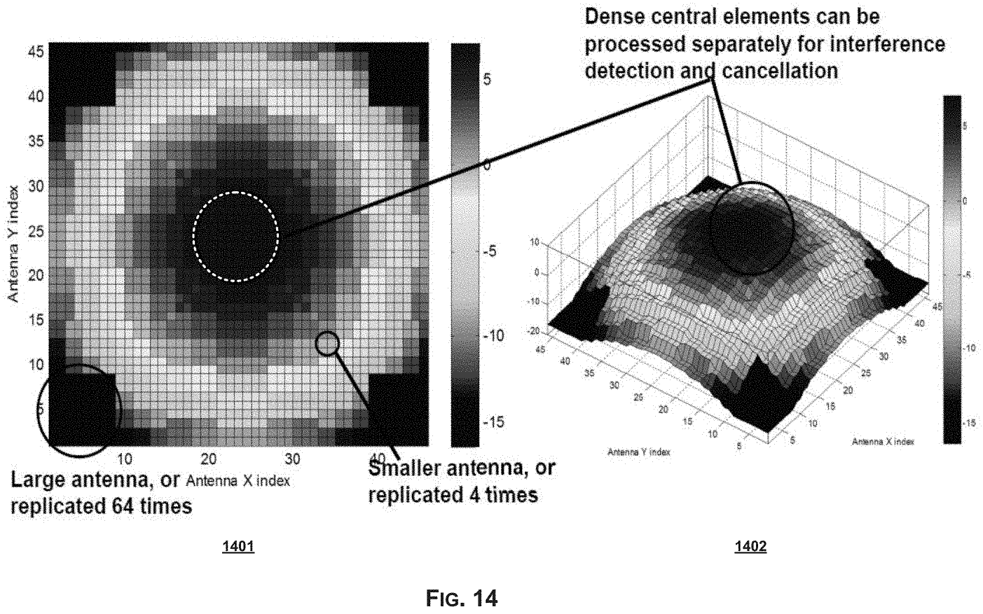

In some implementations, various techniques may be utilized to reduce transceiver count. For example, nonuniform element size and spacing may be utilized. Stochastic element positioning may be utilized—e.g., positioning elements with a deterministic spacing plus an offset with a random or pseudorandom distribution, and accounting for this offset for each element (e.g., phase and amplitude weighting). Also, the densely-spaced central elements may be separately processed, such as to locate and extract interferers for cancellation. Elements may be replicated—e.g., connected to the same transceiver with an on-chip or off-chip combining network. Alternatively element sizes may be varied—e.g., larger or smaller horn antennas. Also, transceivers (and/or Tx or Rx functions therein) may be selectively disabled—e.g., depending on link quality, class of antenna, desired reach, etc. An example of use of such techniques is described in more detail with respect to FIGS. 13 and 14.

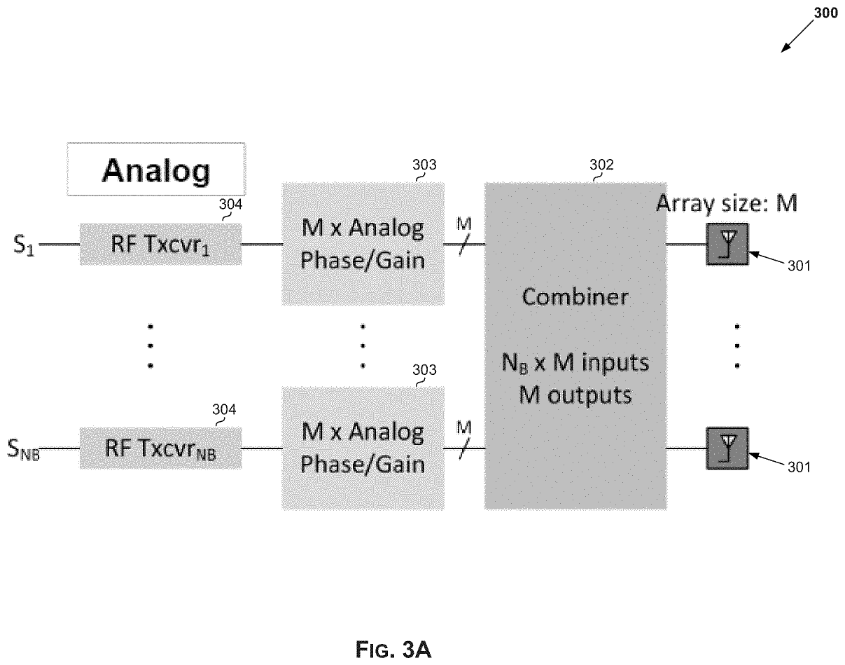

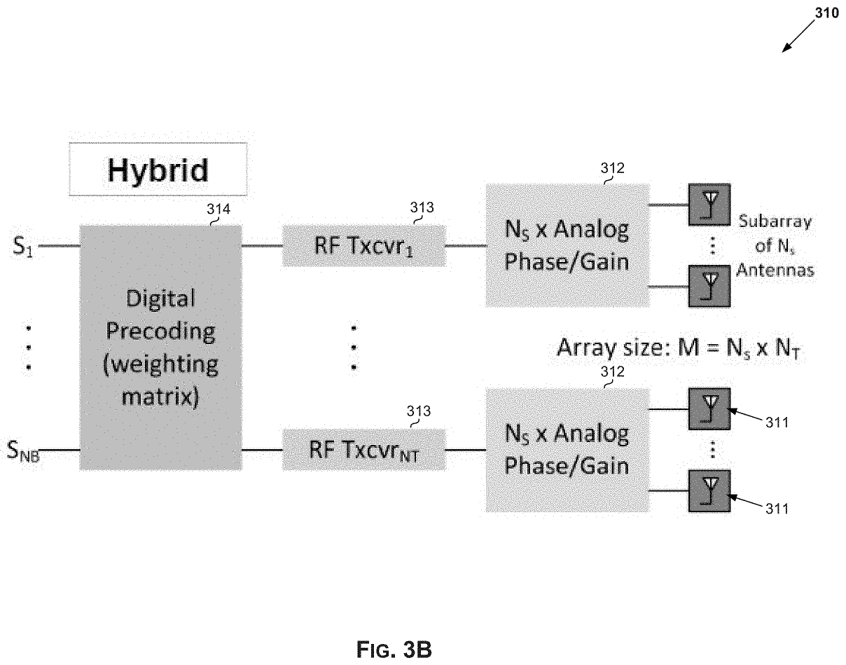

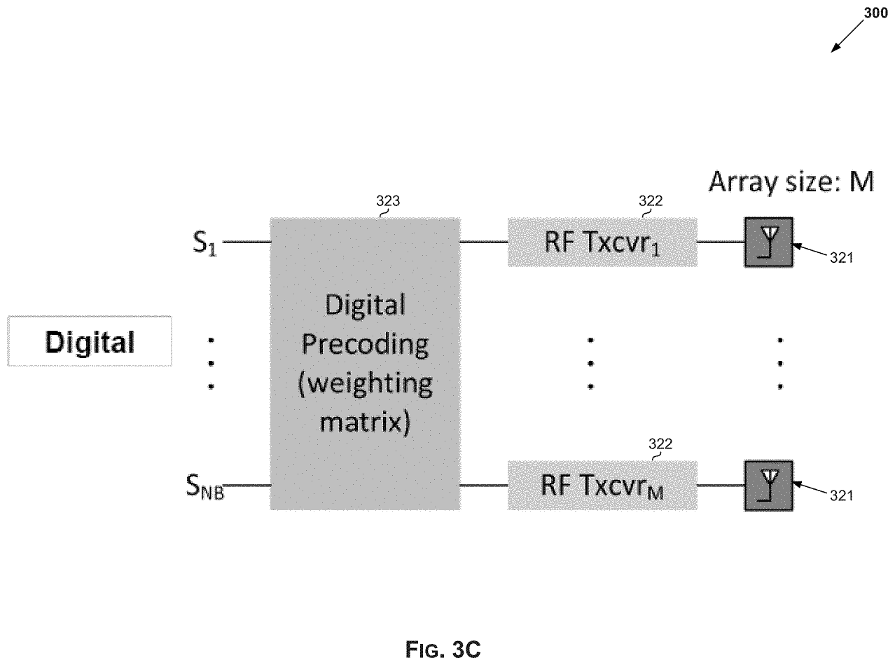

FIGS. 3A-3C illustrate different array architecture designs that may be used in beamforming array-based systems.

Shown in FIG. 3A is an example analog array architecture 300 for utilizing beamforming during transmission or reception of signals corresponding to a plurality of bit streams S₁-S_{NB}. The analog array architecture 300 may comprise an plurality of antenna elements 301. In the example implementation shown in FIG. 3A, the analog array architecture 300 comprises M antenna elements 301.

Because it is analog based design, the analog array architecture 300 must comprise a number of individual RF transceiver elements/circuits corresponding to the maximum number of bit streams it handles. Thus, the analog array architecture 300 comprises NB radio frequency (RF) transceiver circuits 304 (with NB being the number of bits streamed). Further, the analog array architecture 300 comprises NB analog phase/gain circuits 303, with each analog phase/gain circuit 303 handling output of a particular RF transceiver circuits 304.

Each analog phase/gain circuits 303 generates M (corresponding to the number the antenna elements (M) in the array architecture) outputs based on the input from the corresponding to RF transceiver circuit 304 during transmit operations, and receives M inputs to combine into a single output to the corresponding to RF transceiver circuit 304 during receive operations. A combiner 302 routes signals between the M antennas elements 301 and NB analog phase/gain circuits 303. For example, during transmit operations, the combiner 302 combines the NB×M inputs from the analog phase/gain circuits 303 to generate M outputs fed into the antenna elements 301.

Shown in FIG. 3B is an example hybrid array architecture 310 for utilizing beamforming during transmission or reception of signals. The hybrid array architecture 310, similar to the analog array architecture 300, is configured for handling NB bits streams (S₁-S_{NB}). In the hybrid array architecture 310, digital precoding may be performed (e.g., via a digital precoding matrix 314) first on the bit streams, generating NT inputs into transceiver elements and/or handling NT outputs from the transceiver elements.

Accordingly, the hybrid array architecture 310 comprises NT radio frequency (RF) transceiver circuits 313 and NT analog phase/gain circuits 312, with each analog phase/gain circuit 312 handling output of a particular one of the RF transceiver circuits 313 during transmit operations (and input to that particular one of the RF transceiver circuits 313 during receive operations). Each analog phase/gain circuits 313 routs signals between the corresponding one of the RF transceiver circuits 313 with N_{S} antenna elements 311—i.e., a sub-array of N_{S} antenna elements. Thus, the hybrid array architecture 310 comprises N_{S}×NT antenna elements 311.

Shown in FIG. 3C is an example digital array architecture 320 for utilizing beamforming during transmission or reception of signals. The digital array architecture 320, similar to the analog array architecture 300, is configured for handling NB bits streams (S₁-S_{NB}). The digital array architecture 320 is configured to transmit and/or receive digital signals. As such, the digital array architecture 320 does not require phase/gain components, and as such the digital array architecture 320 requires only the same number of transceiver circuits as the number of antenna elements.

Thus, as shown in FIG. 3C, the digital array architecture 320 comprises M radio frequency (RF) transceiver circuits 322 and M antenna elements 321. As with the hybrid array architecture 310, the digital array architecture 320 comprises a digital precoding circuit 323 for performing digital precoding for the NB bit streams. However, digital precoding circuit 323 is configured to generate M inputs into RF transceiver circuits 322, and handling M outputs from the RF transceiver circuits 322.

The use of digital beamforming (e.g., using the digital array architecture 320) may result in various changes (but overall benefits over) other analog beamforming (e.g., using the analog array architecture 300 or the hybrid array architecture 310), particularly with respect complexity and cost, capacity, and RF performance. For example, with respect to complexity and cost, even though analog beamforming represents a conventional approach built on available components and engineering history, RF distribution and signal processing in analog beamforming designs may be costly and may not scale in size and frequency. With digital beamforming, however, transceivers and signal processing may be done in digital CMOS, and costly components such as power amplifiers and duplexers may be eliminated resulting in lower and more streamlined costs.

With respect to capacity, use of analog beamforming may be disadvantageous as simultaneous beams must be spatially clustered, reducing spatial frequency reuse. However, use of digital beamforming may allow for improved capacity, such as due to use of interference cancellation, which enables high order modulation in dense deployments. In addition, duplexer elimination may allow for close Tx/Rx spacing. Further, digital beamforming may support point to multi-point backhaul, further increasing capacity. Use of digital beamforming may also allow for improved RF performance due to superior blocker and noise performance, and because digital beamforming based architecture allows for scaling to larger arrays.

FIG. 4A illustrates an example chip-level architecture for use in a digital beamforming array-based system, in accordance with the present disclosure. Shown in FIG. 4A is chip-level architecture 400 for use in digital beamforming.

The architecture 400, as shown in FIG. 4A, may represent the chip-level architecture utilized for the particular implementation of the digital beamforming array-based system 200 shown in FIG. 2—that is with 64 antenna elements, in 8×8 arrangement. Nonetheless, it should be understood that this is a non-limiting example, and that similar architecture may be implemented in suitable manner based on the particular antenna arrangement utilized.

Accordingly, the architecture 400 may comprise 64 antenna elements 401. Further, the architecture 400 may comprise may comprise a number of transceiver chips 402. For example, as shown in FIG. 4A, the architecture 400 comprises 8 transceiver chips 402, with each one of the transceiver chips 402 handling 8 antenna elements 401 (e.g., connected with 8 particular antenna elements 401).

Each transceiver chip 402 is operable to manage and/or control corresponding 8 antenna elements 401 connected thereto, and/or handling use of these antenna elements during transmission and/or reception of signals. This may comprise performing the required transceiver related functions, including all of the beamforming related functions. Further, the transceiver chips 402 may cooperate with each other during use of the array as a whole—e.g., with respect to beamforming related operations. An example implementation of the transceiver chips 402 is described with respect to FIG. 4B.

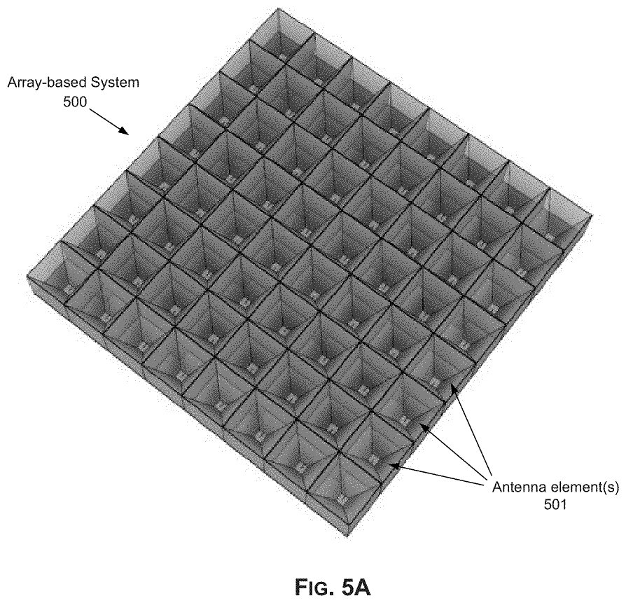

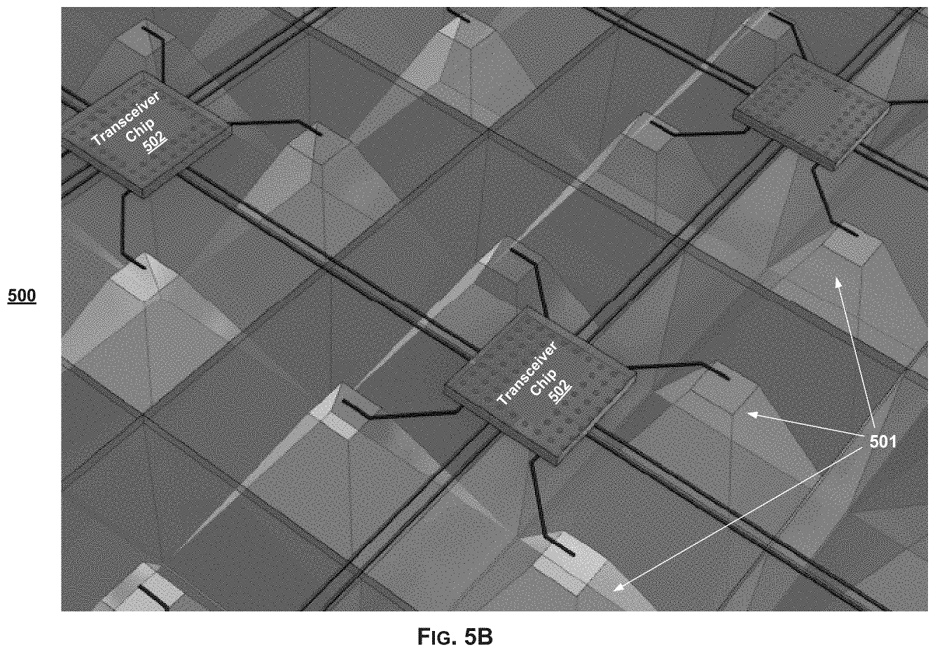

The architecture 400 may also comprise connectors 403 to (and between) the transceiver chips 402, such as to enable routing data (including control data) to and/or from each of chips. For example, the connectors 403 may comprise on-chip based Serializer/Deserializer (SerDes) based links. An example use scenario of the connectors 403 is shown in FIG. 5.

FIG. 4B illustrates an example transceiver chip for use in a digital beamforming based architecture, in accordance with the present disclosure. Shown in FIG. 4B is an example transceiver chip 402, as described with respect to FIG. 4A.

In the non-limiting example implementation shown in FIG. 4B, the transceiver chip 402 may comprise a SerDes interface circuit 411, which may be operable to handle communications to and/or from the transceiver chip 402, via on-chip connectors within the array architecture (e.g., with other chips, with other components sending or receiving the bit streams carried in the transmitted or received signals, etc.).

Further, the transceiver chip 402 may comprise a plurality of transmit/receive sections, each associated with one of the antenna elements associated (connected) with this particular transceiver chip 402. Accordingly, the number of transmit/receive sections is the same as the number of associated antenna elements (thus, for the particular on-chip architecture shown in FIG. 4A, the transceiver chip 402 comprises 8 transmit/receive sections). Each transmit/receive section may comprise a digital phase shift and combiner circuit 413, a transmit path 414, a receive path 415, a transmit front-end 416, and a receive front-end 417. In this regard, the combination of digital phase shift and combiner circuits 413, the transmit paths 414, and the receive paths 415 in the transceiver chip 402 may perform the required digital beamforming processing.

The transceiver chip 402 may comprise a shared radio frequency (RF) phase-locked loop (PLL) 412 for providing shared timing (periodic) signals, for driving various components in the transceiver chip 402—e.g., oscillators used in the transmit/receive sections for transmitting and receiving signals.

Because each antenna element 401 is used for both transmission and reception of signals, selection components 418 may be used to connect each antenna element with either the transmit-side or the receive-side of the corresponding transmit/receive section in the transceiver chip 402. The selection components 418 may be part of the transceiver chip 402, or may be separate from and external to the transceiver chip 402. The selection components 418 may be configured as switches, active circulators, etc.

FIG. 4C illustrates example data flows in chip-level architecture during digital beamforming, in accordance with the present disclosure. Shown in FIG. 4C is the architecture 400 described with respect to FIG. 4A.

As shown in FIG. 4C, data (corresponding to, e.g., bit streams that are to be transmitted) flows in the architecture via the connectors (e.g., SerDes links) 403 into the transceiver chips 402, which may then perform the necessary signal processing (including digital beamforming processing) to generate corresponding RF signals for transmission via the antenna elements 401. This may comprise performing digital beamforming related processing (and adjustments, as described below).

FIGS. 5A-5B illustrate example improvements in digital beamforming array-based systems, in accordance with the present disclosure.

Shown in FIGS. 5A-5B is an example digital beamforming array-based system 500. In this regard, as with the digital beamforming array-based system 200 shown in FIG. 2, digital beamforming array-based system 500 may also be implemented with an array of 64 antenna elements 501, arranged in 8×8 manner. As shown in FIG. 5A, each antenna element 501 may be a horn antenna. The digital beamforming array-based system 500 may be configured and/or may operate as described above—e.g., with respect to digital beamforming array-based system 200, and may comprise a suitable on-chip architecture, similar to chip-level architecture 400 of FIGS. 4A-4C.

The use of array based design (e.g., the array-based system 500), along with digital beamforming, may reduce or mitigate some of the shortfalls of existing, conventional designs. For example, the use of antenna elements (rather than a single dish) may allow for distributed power generation, resulting in reduced (or even no) thermal hot spots.

Further, as illustrated in FIG. 5B, because array-based systems like the array-based system 500 comprise multiple antenna elements (rather than a single dish), and because they may be implemented in manner where subsets of the antenna elements may be controlled separately (e.g., using groups of transceiver chips 502 and corresponding antenna elements, as shown in FIGS. 4A-4C), these array-based systems may be robust with respect to failure of individual elements. Thus, in instances where one transceiver chip 502 may fail, such failure may only affect the corresponding antenna elements; remaining antenna elements, however, may remain functional and usable.

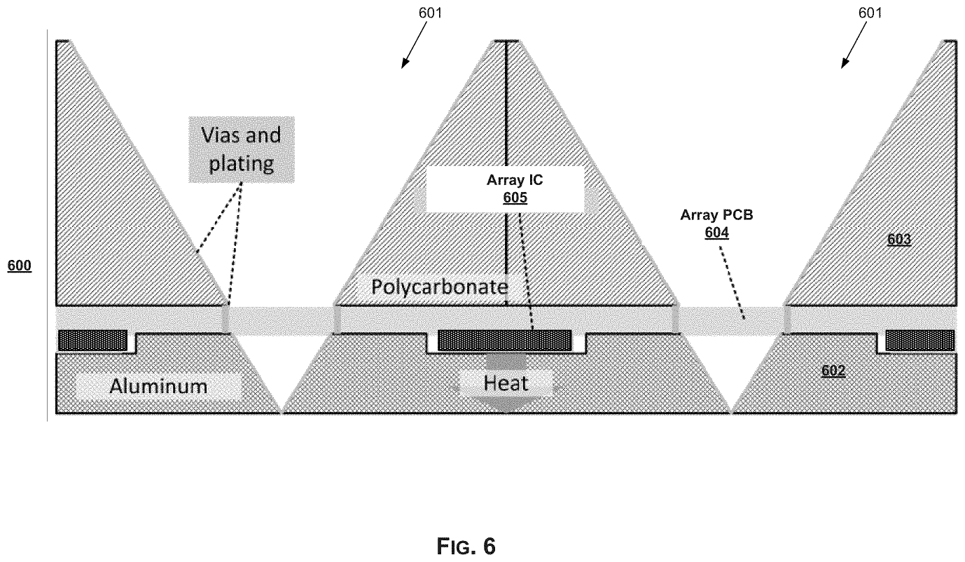

FIG. 6 illustrates a cross-section in an example digital beamforming array-based system, in accordance with the present disclosure, showing material stack-up in such system. Shown in FIG. 6 is a cross-section slice in an example digital beamforming array-based system 600.

The digital beamforming array-based system 600 may comprise a plurality of antenna elements 601, of which two elements are shown in the cross-section slice depicted in FIG. 6. The antenna elements 601 may be horn-shaped. The digital beamforming array-based system 600 may comprise a base structure 602, which may be metal-based (e.g., aluminum). The horn-shaped antenna elements may be formed using carved horn structure 603, which may comprise polycarbonate (or plastics) based material, with plating covering the surfaces forming the horn-shaped antenna elements.

In between the base structure 602 and the horn structure 603, a main array printed circuit board (PCB) 604 may be incorporated, such as to provide RF traces to the antenna elements. Within the base structure 602, an array integrated circuit (IC) 605 (e.g., system-on-chip (SoC)) may be embedded to provide the processing functions, utilizing the main array PCB 604 for RF traces to antenna elements. Further, because of the placement of the array IC 605 and the configuration of the base structure 602, there may be low thermal resistance from array IC 605, allowing for enhanced thermal dissipation.

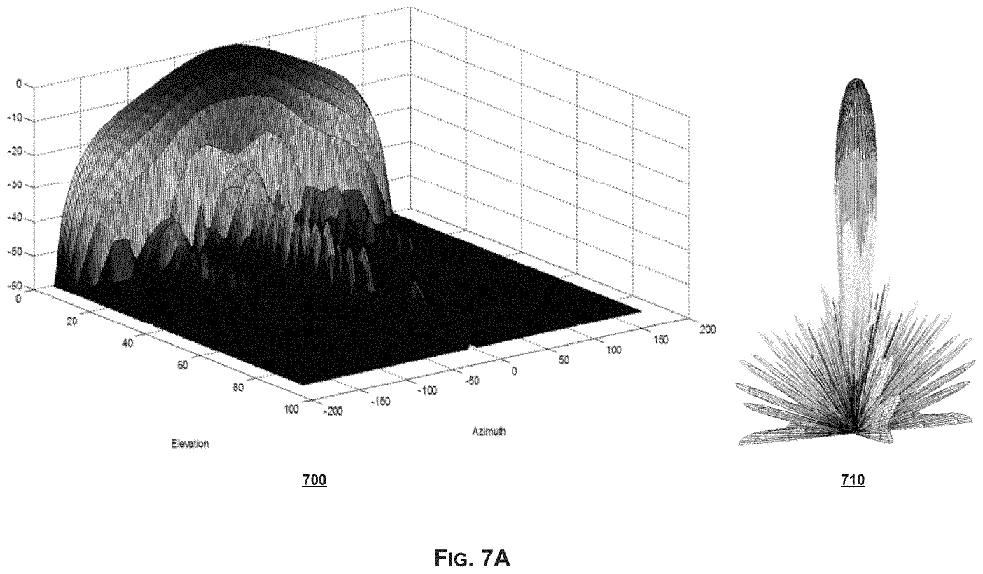

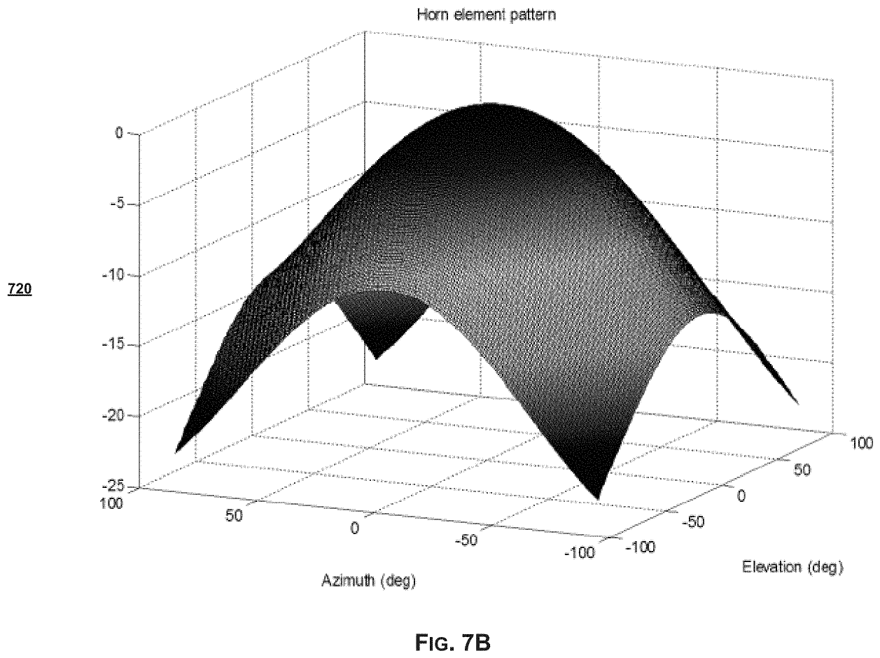

FIGS. 7A-7B illustrate examples of simulated array radiation in a digital beamforming array-based system, in accordance with the present disclosure.

Shown in FIG. 7A is a chart 700 illustrating an example simulation-based antenna pattern for an example digital beamforming array-based system, in accordance with the present disclosure. In chart 700, the z-axis represents the antenna gain, with the x-axis and y-axis corresponding to the elevation and azimuth (both relative the main direction of the antenna—i.e., with 0 representing the direction of the main beam of the antenna), respectively. This is further illustrated in chart 710, which represents a three dimensional rendition of the same antenna pattern.

As shown in charts 700 and 710, digital beamforming array-based system may provide strong directionality. The antenna pattern illustrated in charts 700 and 710 comprises a large and narrow main lobe in the main direction (corresponding to azimuth 0 and elevation 0) with small sidelobes in the other directions. The directionality of the antenna may be further enhanced (e.g., the sidelobes further reduced), based on digital processing of the transmitted or received signal.

Shown in FIG. 7B is a chart 720 illustrating an example simulation-based pattern for element in an example digital beamforming array-based system, in accordance with the present disclosure. As illustrated in chart 720, the antenna elements may have pyramidal horn profile. The pyramidal horn profile may be easily designed for symmetric E/H-plane, sidelobes, and efficiency.

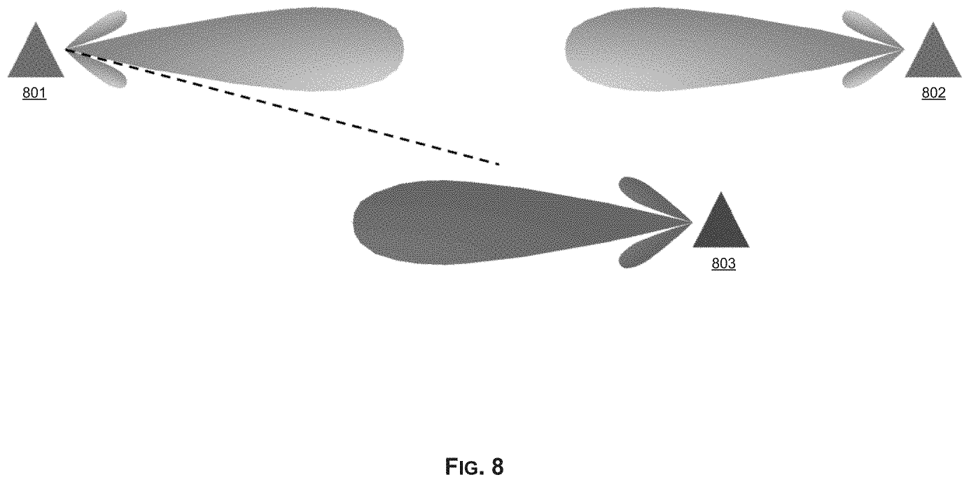

FIG. 8 illustrates examples use scenario of interference cancellation for higher frequency reuse using digital beamforming array-based systems, in accordance with the present disclosure. Shown in FIG. 8 are three antenna elements 801, 802, and 803, in digital beamforming array-based systems (not shown).

Digital beamforming array-based systems may be particularly suitable for interference cancellation. In this regard, use of interference cancellation may be impact System design and operations. For example, smaller dish achieves better performance in interference-limited environment. This in turn enables higher order modulation and greater spatial frequency reuse, resulting in increased system throughput.

Further, smaller dish result in lower costs (e.g., lower capital expenditure, lower operating expense, etc.). Multiple interference sources can be located and suppressed in digital silicon. The ability to proactively suppress interferences at the receiver and transmitter can both proactively suppress interference may allow for simplified network, site, and frequency planning/allocation—e.g., allows for dynamically changing frequency bands with loading.

With respect to the use scenario shown in FIG. 8, the digital beamforming array-based systems, comprising the antenna elements 801, 802, and 803, may configure operations of these antenna elements to cancel interference to enable frequency reuse, thus allowing for dense reuse of licensed spectrum. In this regard, with digital beamforming array-based systems adaptive and proactive interference suppression may be used to simplify network planning. In the particular use scenario shown in FIG. 8, the antenna elements 801 and 802 may be configured to focus their transmissions as to optimize communications therebetween.

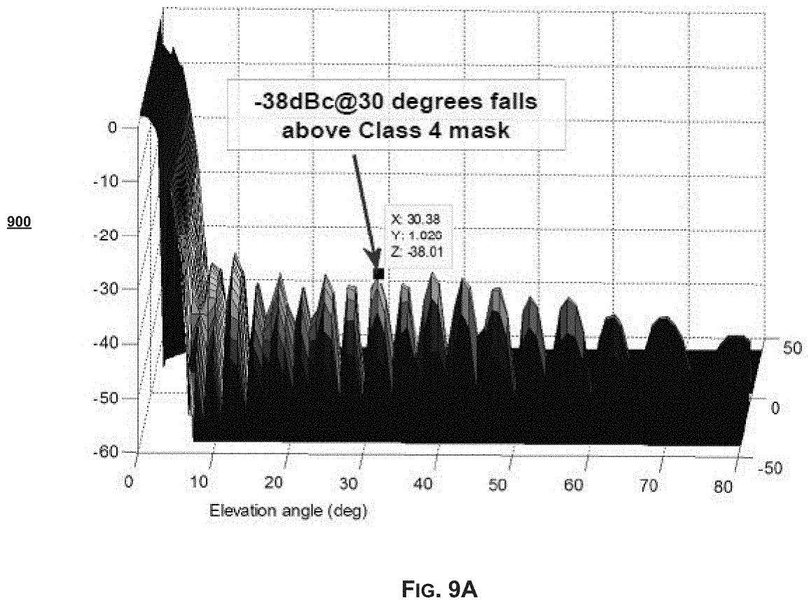

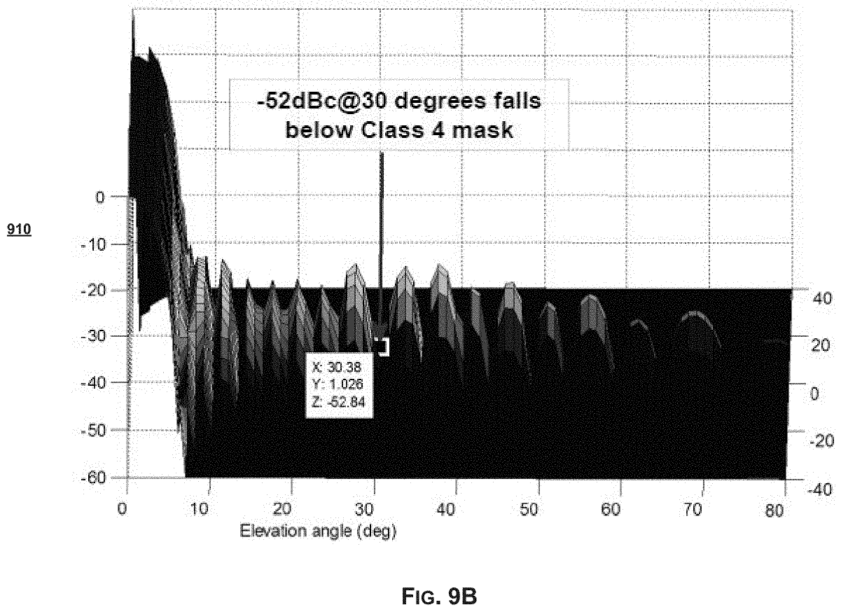

Further, the antenna elements 801 and 803, which (without any adjustment) may interfere with one another, may be configured such that their respective signals would be cancelled out, thus allowing these two antenna elements to operate without interfering with one another. This may be done by configuring each of the antenna elements 801 and 803 to proactively suppress interference that may be introduced by the signals of the other one of the antenna elements 801 and 803. A simulation of such cancellation is shown with respect to FIGS. 9A and 9B.

FIGS. 9A-9B illustrate an example of interference (sidelobe) cancellation simulation in digital beamforming array-based systems, in accordance with the present disclosure.

Shown in FIG. 9A is a chart 900 representing three-dimensional simulation of transmission profile for a particular antenna element in digital beamforming array-based system. In this regard, chart 900 represented the transmission profile without any adjustment (e.g., without any suppression). As shown in chart 900, a particular sidelobe (e.g., at 30 degrees) may constitute an interferer to another antenna element (e.g., at −38 dBc, falling above Class 4 mask).

Shown in FIG. 9B is a chart 910 representing three-dimensional simulation of transmission profile for the particular antenna element described in FIG. 9A, but with adjustment for interference suppression. In this regard, as shown in chart 910, the same particular sidelobe (e.g., at 30 degrees) may now be suppressed (e.g., at −52 dBc, falling below Class 4 mask) to ensure that it now long constitute an interferer to that other antenna element.

In some instances, similar suppression adjustments (e.g., >15 dB) may be extended to multiple interferers. Further, transmit and receive cancellation may be independently adjusted.

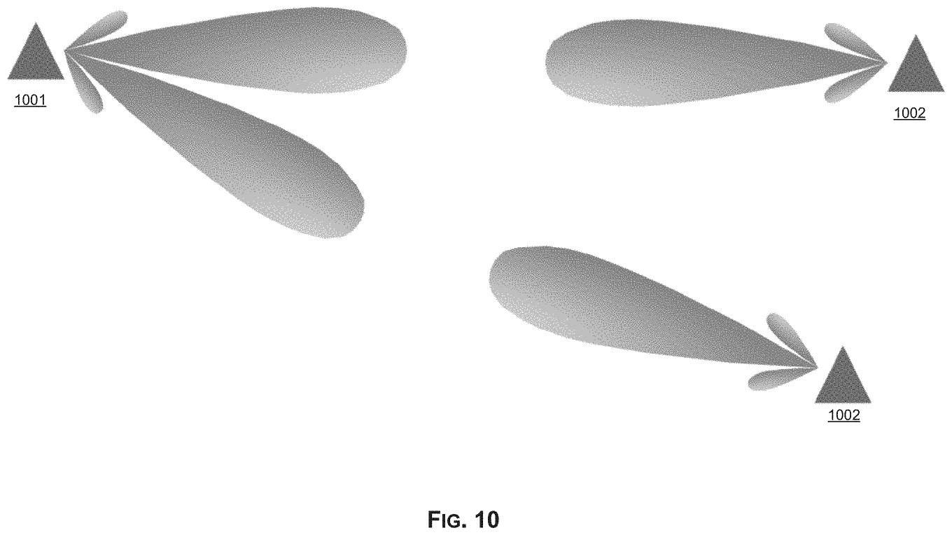

FIG. 10 illustrate examples use scenario of multi-point-to-multi-point transmissions using digital beamforming array-based systems, in accordance with the present disclosure. Shown in FIG. 10 are three antenna elements 1001, 1002, and 1003, in digital beamforming array-based systems (not shown).

Digital beamforming array-based systems may be particularly suitable for multi-point-to-multi-point transmissions. In this regard, antenna elements may be configured for concurrent transmissions to and/or reception from different other antenna elements. With respect to the use scenario shown in FIG. 8, for example, the digital beamforming array-based systems, comprising the antenna elements 1001, 1002, and 1003, may configure operations of these antenna elements such that to enable antenna element 1001 to transmit to and receive from each of antenna elements 1002 and 1003. This may be done by applying beamforming processing to allow for directed transmissions between antenna element 1001 and each of antenna elements 1002 and 1003. Further, interference cancellation may be utilized (e.g., during digital processing) to ensure that the transmissions do not interfere with one another.

Use of multi-point-to-multi-point transmissions may have many advantages. For example, multi-point-to-multi-point transmissions may allow for reducing costs (e.g., reducing tower lease costs as less elements are used, less power per link, etc.) and/or may supports a failure-resistant mesh topology. This is may be particularly valuable to certain types of communication (e.g., mmW communications).

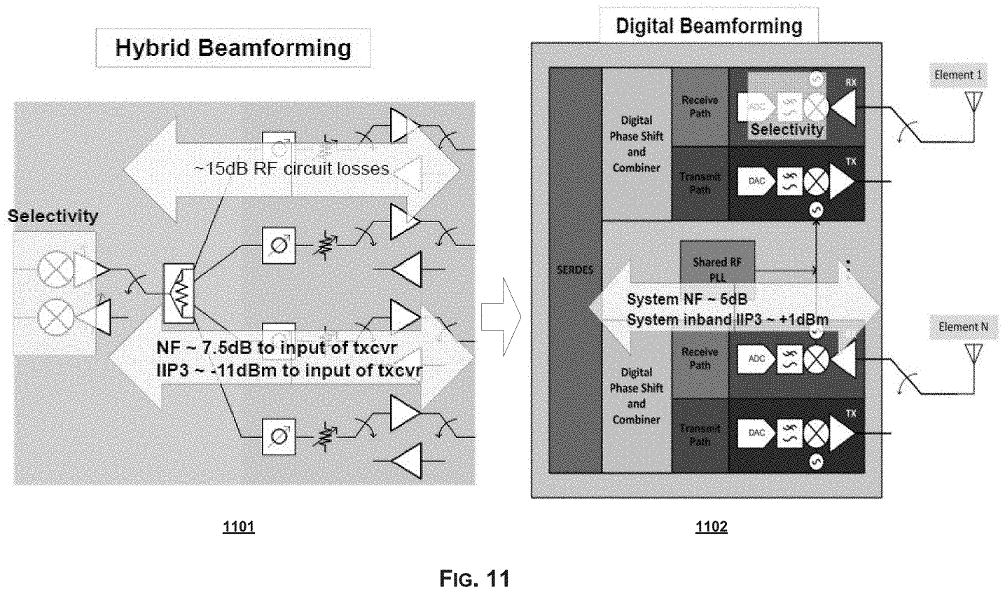

FIG. 11 illustrates performance comparison between hybrid beamforming based design and digital beamforming based design. Shown in FIG. 11 is hybrid beamforming circuitry 1101 and digital beamforming circuitry 1102.

In this regard, the hybrid beamforming circuitry 1101 and the digital beamforming circuitry 1102 may be utilized in a hybrid beamforming system and a digital beamforming system, respectively.

As illustrated in FIG. 11, the use of digital beamforming (e.g., via the digital beamforming circuitry 1102) may allow for substantial improvement in RF performance in the system—for transmission of the same data. For example, as shown in FIG. 11, the hybrid beamforming circuitry 1101 may have noise figure (NF), from input to transceiver, of ˜7.5 dB and third order intercept point (IIP3) of ˜−11 dB. In comparison, the digital beamforming circuitry 1102 may have noise figure (NF) of ˜5 dB and third order intercept point (IIP3) of ˜+11 dB. Thus, hybrid beamforming circuitry 1101 may exhibit about ˜15 dB more RF circuit losses compared to the digital beamforming circuitry 1102.

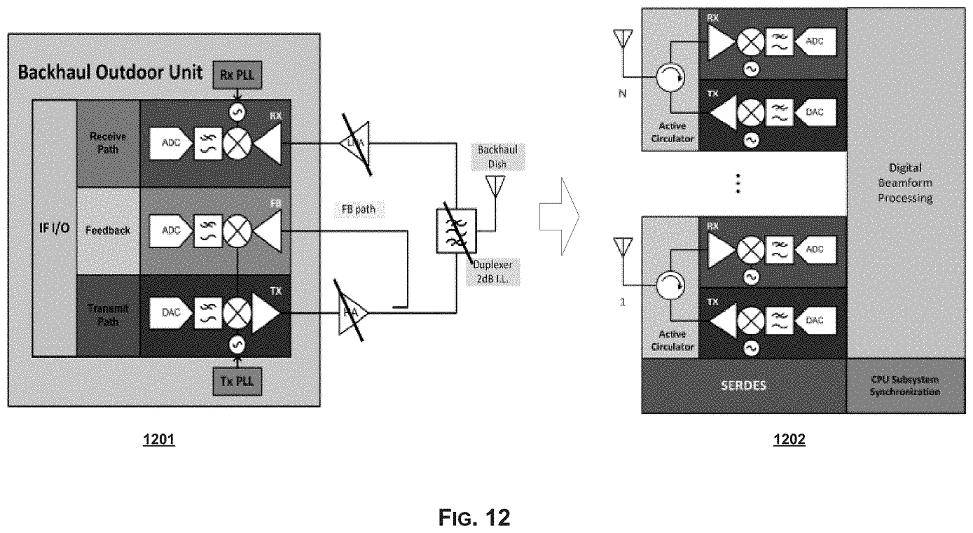

FIG. 12 illustrates performance comparison between dish-duplexer based design and digital beamforming based design. Shown in FIG. 12 is transmit/receive circuitry 1201 and digital beamforming circuitry 1202.

In this regard, the transmit/receive circuitry 1201 and the digital beamforming circuitry 1202 may be utilized in a traditional backhaul outdoor unit and a digital beamforming system, respectively.

As illustrated in FIG. 12, the use of digital beamforming (e.g., via the digital beamforming circuitry 1202) may allow for substantial improvement in performance in the system—for transmission of the same data—in comparison to a traditional design. In this regard, the use of digital beamforming based design allows for the elimination of such components as the duplexers, power amplifiers (for the transmit-side), and low-noise amplifiers (on the receive-side).

Further, on the transmit-side each array contains a large number (e.g., hundreds) of very low-power Tx/Rx elements (e.g., Tx power for each element may be ˜1000 times lower than traditional backhaul—about ˜0 dBm). Thus, total Tx power may be >30 dBm, and may scale with array size. On the receive-side, Rx linearity and use of components such as the active circulator, may allow receiver element(s) to handle Tx power directly. Thus, the need for Tx/Rx guard band may be elimination, allowing for reclaiming valuable spectrum.

Further, as noted above, the use of digital beamforming array-based systems allows for improvement to reliability. For example, digital beamforming array-based systems may have significantly-reduced max operating junction temperature (e.g., by >20 C). In this regard, reliably may have exponential dependence on temperature—e.g., a ˜3× better electromigration that may achieved with array-based systems may result in substantial improvement (e.g., ˜10×) in mean time between failures (MTBF). Array-based systems may also have low power/chip and architectural heat spreading, resulting in reduced heat sink requirements.

Further, array-based systems may allow for spatial power combining, which in turn allows for elimination of PA hotspot, and thus elimination PA-related heating and failures. Local digital pre-distortion (DPD) also increases individual PA efficiency, thus reducing local heating. Further, array architecture reduces stress on digital and analog circuitry. In this regard, the distributed RF power generation reduces peak voltages on all components. In addition, array gain reduces signal path width, which in turn results in eased timing requirements, thus lowering clock tree power. Array-based systems also exhibit robustness to failure (graceful degradation). For example, failure of one chip may have negligible effect on link budget.

FIG. 13 illustrates example profiles of different antenna classes. Shown in FIG. 13 is a chart 1300 illustrating example performance requirements for different classes of antennas (class 2, class 3, and class 4).

In this regard, chart 1300 represents the performance requirement for class 2, class 3, and class 4 antennas, as set forth by the European Telecommunications Standards Institute (ETSI). In chart 1300, the y-axis represent the antenna maximum gain (in dBi) and the x-axis represent the azimuth (relative to the main beam of the antenna—i.e., with 0 representing the direction of the main beam of the antenna). Accordingly, chart 1300 illustrated the required criteria that antennas must meet to qualify as class 2, class 3, or class 4 antenna, particularly with respect to the gain of their sidelobes (for particular azimuth degrees).

The antenna class requirement may be utilized in conjunction with adaptive configuration and/or operation of digital beamforming array-based systems. For example, interference cancellation (for reduction of sidelobes) or transceiver count reduction techniques may be configured or adjusted based on pre-defined antenna class requirements (e.g., adaptively applying interference cancellation to ensure that sidelobes at particular degree meet particular antenna class requirement, as described above with respect to FIGS. 9A-9B).

FIG. 14 illustrates example nonuniform array configuration, in accordance with the present disclosure. Shown in FIG. 14 is charts 1401 and 1402 illustrating an example simulation-based antenna pattern for an example digital beamforming array-based system, incorporating use of transceiver count reduction techniques, in accordance with the present disclosure.

In chart 1401, which is a 2-dimensional plane, the x-axis and y-axis corresponding to the positioning (e.g., index) of the antenna elements in the array. Thus, the antenna array shown in particular example implementation illustrated in chart 1401 has 2025 elements, in 45×45 arrangement. The antenna array may be configured, using transceiver count reduction techniques, to have denser central elements relative to the edge/corner elements. This may be done by using smaller (sized) antennas for the central elements (or by replicating them smaller number of times—e.g., 4 times), and/or by using larger (sized) antennas for the edge elements (or by replicating them larger number of times—e.g., 64 times).

Chart 1402, illustrates the effects (in the z-axis, added to chart 1401) of adjusted size/number of elements in the antenna array. The dense central elements can be processed separately for interference detection and cancellation.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system, comprising:
a plurality of antenna elements arranged in two-dimensional array;
a plurality of transceiver chips configured for handling transmission and reception of radio frequency (RF) signals via the plurality of antenna elements;
wherein:
a number of transceiver chips in the plurality of transceiver chips is less than a number of antenna elements in the plurality of antenna elements; and
the plurality of transceiver chips is configured to control operation of the plurality of antenna elements such that digital or hybrid beamforming is enabled during the transmission and reception of RF signals via the plurality of antenna elements.

2. The system of claim 1, wherein at least one transceiver chip from the plurality of transceiver chips is configured to control and/or handle two or more antenna elements from the plurality of antenna elements.

3. The system of claim 1, wherein each transceiver chip from the plurality of transceiver chips is configured to control and/or handle two or more antenna elements from the plurality of antenna elements.

4. The system of claim 3, wherein each transceiver chip from the plurality of transceiver chips is configured to control and/or handle four antenna elements from the plurality of antenna elements.

5. The system of claim 1, wherein the plurality of transceiver chips are arranged on a back-side of the two-dimensional array.

6. The system of claim 1, wherein the plurality of transceiver chips are embedded within the two-dimensional array.

7. The system of claim 1, comprising at least one digital precoding chip.

8. The system of claim 1, comprising one or more connectors configuring for enabling communications among the plurality of transceiver chips, and communications within the system, to and/or from each of the plurality of transceiver chips.

9. The system of claim 8, wherein the one or more connectors comprise on-chip based Serializer/Deserializer (SerDes) connectors.

10. The system of claim 8, wherein each transceiver chip in the plurality of transceiver chips comprises an interface circuit configured for handling communications to and/or from the transceiver chip, via the one or more connectors.

11. The system of claim 1, wherein each transceiver chip in the plurality of transceiver chips comprises one or more circuits for handling signals transmitted and received via at least one antenna element in the plurality of antenna elements.

12. The system of claim 11, wherein each transceiver chip comprises one or more digital phase shift and combiner circuits.

13. The system of claim 11, wherein each transceiver chip comprises a timing control circuit configured for providing shared timing signals for driving circuits in the transceiver chips used in handling the transmitted and received signals.

14. The system of claim 11, wherein a transceiver chip in the plurality of transceiver chips that control and/or handle two or more antenna elements, the one or more circuits comprise corresponding two or more circuits each configured for handling different one of the two or more antenna elements.

15. A transceiver chip configured for handling transmission and reception of radio frequency (RF) signals via two or more antenna elements from a plurality of antenna elements in an array-based system; the transceiver chip comprising:
a plurality of circuits that comprise at least at least two sets of circuits corresponding to the two or more antenna elements;
wherein:
each set of circuits is configured for handling signals transmitted and received via a corresponding antenna element; and
the transceiver chip is configured to control operation of the two or more antenna elements such that digital or hybrid beamforming is enabled during the transmission and reception of RF signals via the plurality of antenna elements.

16. The transceiver chip of claim 14, wherein each set of circuits comprises a digital phase shift and combiner circuit.

17. The transceiver chip of claim 14, wherein each set of circuits comprises two separate sub-sets arranged for separately handling transmitted signals and received signals.

18. The transceiver chip of claim 14, wherein the plurality of circuits comprises a timing control circuit configured for providing shared timing signals for driving the sets of circuits.

19. The transceiver chip of claim 14, wherein the plurality of circuits comprises an interface circuit configured for handling communications to and/or from the transceiver chip, within the array-based system.

20. The system of claim 19, wherein the interface circuit is configured for handling Serializer/Deserializer (SerDes) based communications.
